(19) United States
(12) Patent Application Publication
(10) Pub. No.: US 2010/0238778 A1
(43) Pub. Date: Sep. 23, 2010

(54) READING METHOD OF OPTICAL DISC DRIVE

(76) Inventors: Shih-Kuo Chen, Taoyuan County (TW); Chin-Fa Hsu, Taoyuan County (TW); Shiu-Ming Chu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/692,650

(22) Filed: Jan. 25, 2010

(30) Foreign Application Priority Data
Mar. 17, 2009 (TW) 098108706

(51) Int. Cl. G11B 20/18

(52) U.S. Cl. 369/53.35; G9B/20.046

(57) ABSTRACT

The invention provides a reading method of an optical disc drive, which includes setting, reading, and decoding data, accumulating the error amount of the decoded data, setting to re-read the data when a reading failure occurs, adding one to the error amount, setting a low number of retry attempts for a high error amount and a high number of retry attempts for a low error amount based on the error amount, retrying to re-read the data if the number of retry attempts does not reach the predetermined number of retry attempts, and determining that the reading fails if the number of retry attempts reaches the predetermined number of retry attempts.

### BACKGROUND OF THE INVENTION

1. Field of the Invention

The present invention relates to a reading method of optical disc drives, and more particularly, to a reading method that sets a maximum number of retry attempts of a reading operation when a reading error occurs in an optical disc drive.

2. Description of the Prior Art

Optical discs usually suffer from the effects of slight stains, dust and scratches on their surface, writing quality, and noise signal caused in reading process, causing reading errors. Due to these variable factors, the optical disc drive needs to re-read an optical disc multiple times in order to complete a reading operation.

A conventional reading method of optical disc drives is to set a target data location to be read after receiving a reading instruction from a host, and then to read the data marks in the target data location of an optical disc. Error correction code (ECC) is utilized to perform correction and decoding for the data marks to derive the original data. If the decoding cannot be performed correctly, the data cannot be read from the optical disc. In order to prevent temporary reading errors due to nonpermanent factors such as dust, stain or noise, the data must be re-read again. Since the causes leading to reading errors cannot be confirmed, the conventional technique will set a predetermined and fixed number of retry attempts as an upper limit of re-reading to try to read the data. When the number of retry attempts reaches the predetermined number, a reading error message is sent to the host, instructing the host to finish the reading process and wait for a next reading instruction.

The conventional reading method of optical disc drives utilizes the predetermined number of retry attempts to re-read data; however, as the predetermined number of retry attempts in conventional reading is fixed, no matter whether the factors leading to reading errors are variable or permanent, the reading will be performed for the predetermined number. For example, for an optical disc with data marks of poor quality, if an identical number of retry attempts is utilized, the optical disc drive will spend a lot of time on re-reading while still encountering identical reading errors, i.e. the retry attempts are redundant. More particularly, for high-volume blu-ray discs with relative tiny data marks, re-reading rates are higher and therefore even more time is consumed, leading to a lower reading efficiency of the optical disc drives. Therefore, the conventional reading method of conventional optical disc drives still has issues to be solved on the setting of a number of retry attempts.

### SUMMARY OF THE INVENTION

One objective of the present invention is to provide a reading method of an optical disc drive. For areas with a low error amount of correcting and decoding data during a reading process, a high number of retry attempts is set to increase the opportunity of a successful reading process. For areas with a high error amount, a low number of retry attempts is set to reduce a number of redundant retry attempts to reduce the time of retry attempts.

Another objective of the present invention is to provide a reading method of optical disc drives which utilizes a data decoding error amount during a reading process to selectively set a number of retry attempts to enhance reading efficiency.

Yet another objective of the present invention is to provide a reading method of optical disc drives which utilizes an average decoding error amount of a reading area to select a number of retry attempts to accurately set the number of retry attempts.

To achieve the aforementioned objectives, the present invention performs the steps of setting, reading, and decoding data, accumulating the error times of decoding data, setting to retry reading the data when a reading failure occurs, adding one to the error amount, setting a low number of retry attempts for a high error amount and a high number of retry attempts for a low error amount based on the error times, retrying to read the data if the number of retry attempts does not reach the predetermined number of retry attempts, and determining a reading fails if the number of retry attempts reaches the predetermined number.

For the reading method of the present invention, when setting the number of retry attempts, the error amount of correction and decoding are categorized into multiple scales, and the number of retry attempts is set according to a predetermined corresponding scale. In addition, a sector number of reading in reading areas is derived. Dividing the error amount of correction and decoding by the sector number derives an average error amount, and the number of retry attempts is set according to the average error amount to set the number of retry attempts accurately.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a reading method of optical disc drives according to an embodiment of the present invention.

FIG. 2 is a flowchart of a reading method of optical disc drives according to a practical implementation of the present invention.

FIG. 3 is a flowchart of categorizing a number of retry attempts into three ranges according to an embodiment of the present invention.

FIG. 4 is a flowchart of setting a number of retry attempts according to another embodiment of the present invention.

### DETAILED DESCRIPTION

To illustrate the adopted techniques and effect of this invention described in the aforementioned statement, an actual example along with figures and an accompanying detailed description is provided below.

For conventional optical disc drives, data marks on the optical disc are read and decoded via error correction code (ECC) to be recovered as original data. In the process of decoding, conventional ECC utilizes specific coding format to correct error signals of reading data marks, and accumulates an error amount. If all the error signals in the reading are corrected, the data can be read successfully, otherwise, a correction error will lead to a reading failure. Therefore, the error amount of ECC indicates a quality of data marks in a reading area.

The reading method of the optical disc drive in the present invention utilizes the error amount in conventional ECC as a standard to determine a quality of data marks in each area of an optical disc. For areas of low ECC error amount (in other words, areas of good-quality data marks), a high number of retry attempts is set and data are re-read multiple times, leading to a higher probability of correcting error signals and completing a reading instruction. On the other hand, for areas of high ECC error amount, i.e., areas of poor-quality data marks, a low number of retry attempts is set to reduce re-reading time, and therefore the optical disc drive can quickly change to read a next data area.

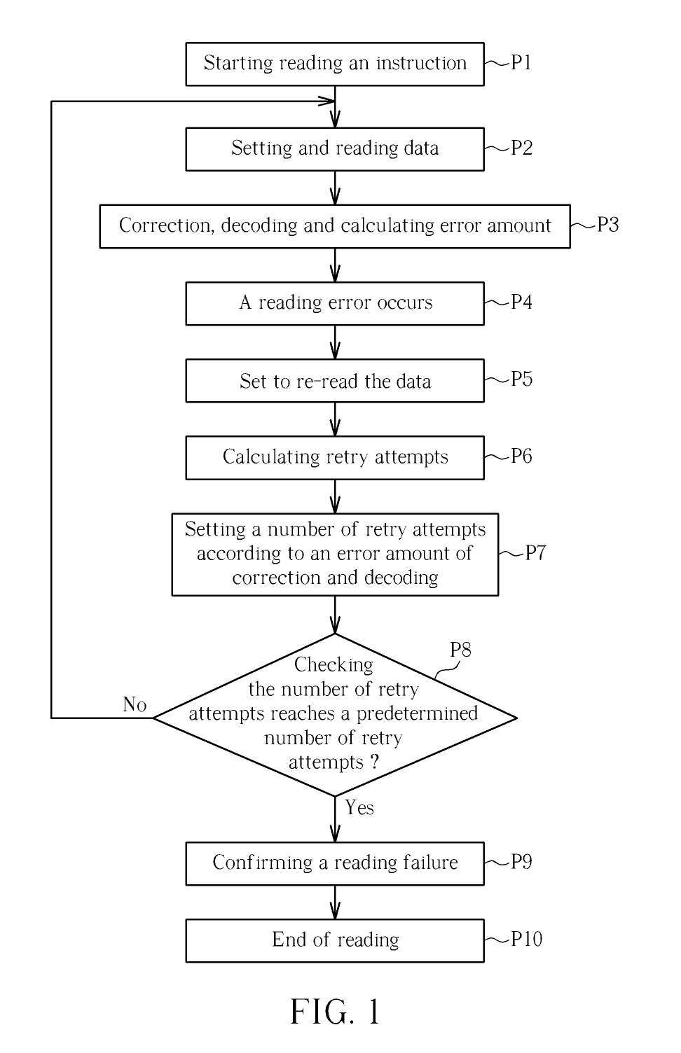

Please refer to FIG. 1, which is a flowchart of a reading method of optical disc drives according to an embodiment of the present invention. The steps of dynamically adjusting reading error and setting a number of retry attempts according to ECC error amounts in the reading method of the present invention are detailed as follows: in step P1, reading data on an optical disc is started. In step P2, data to be read are set and read. In step P3, ECC is utilized to correct and decode the data to be read, and error amounts during a decoding process are calculated. In step P4, when the correction and decoding is not successful, a reading failure occurs. In step P5, it is set to re-read the data, and a number of retry attempts is accumulated by one in step P6. In step P7, the error amount derived in step P3 is referred to, a predetermined low number of retry attempts for a high error amount is set, and a predetermined high number of retry attempts for a low error amount is set. In step P8, it is checked whether the number of retry attempts reaches the corresponding predetermined number of retry attempts. If the corresponding predetermined number of retry attempts is not reached, the flow returns to step P2 to again set and re-read the data. If the corresponding predetermined number of retry attempts is reached, the flow goes to step P9, to confirm a reading failure, and then proceeds to step P10 to finish the reading process.

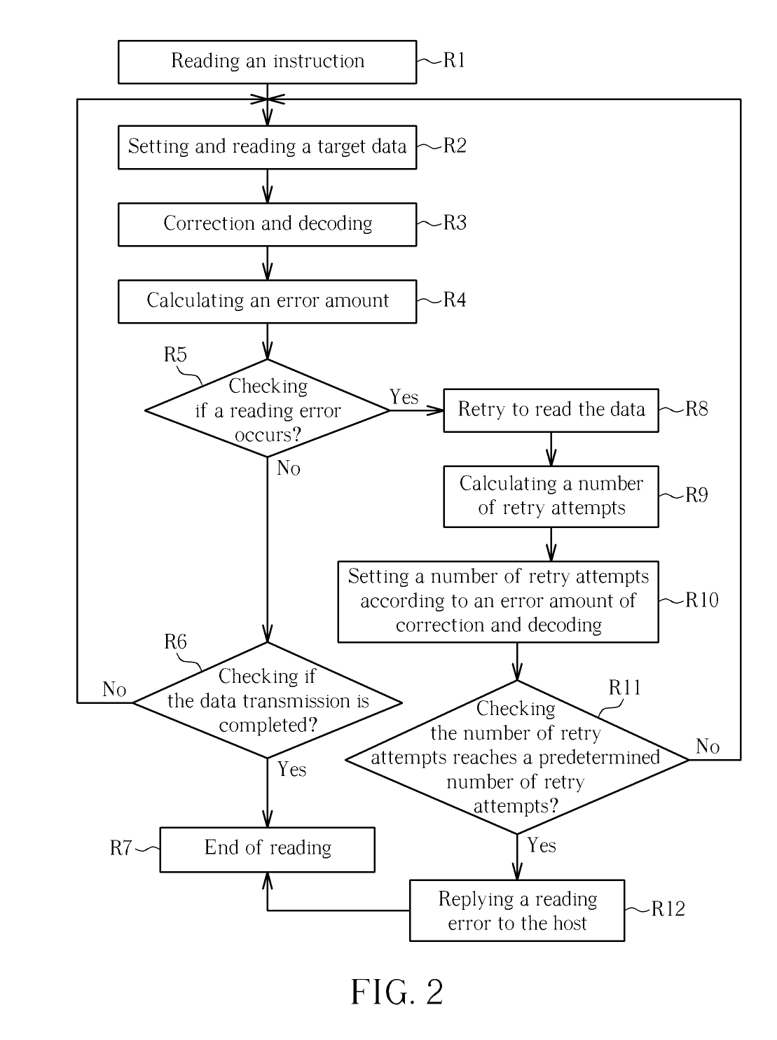

Please refer to FIG. 2, which is a flowchart of a reading method of optical disc drives according to a practical implementation of the present invention. The steps of applying the reading method of the present invention on a host connecting to an optical disc drive is detailed as follows: in step R1, the optical disc drive receives a reading instruction from the host. In step R2, a target location of reading data is set according to the reading instruction and data marks at the target location on the optical disc are read. In step R3, ECC is utilized to correct and decode data marks to be read, and an error amount during correction and decoding in step R4 is calculated. Next in step R5, it is checked if a reading error occurs. If no reading error occurs, the flow goes to step R6 to check whether the data transmission is completed. If the data transmission is not completed, the flow returns to step R2 to continue setting and reading data. If the data transmission is completed, the flow proceeds to step R7 to finish the reading process and wait for an instruction from the host to read another data.

When a reading error occurs during the checking in step R5, the flow goes to step R8 to re-read the data, and a number of retry attempts is accumulated by one in step R9. In step R10, the error amount derived during correction and decoding in step R4 is referred to, a predetermined low number of retry attempts for a high error data amount is set, and a predetermined high number of retry attempts for a low error data amount is set. The flow goes to step R11 again to check if the number of retry attempts reaches the corresponding predetermined number of retry attempts. If the corresponding predetermined number of retry attempts is not reached, the flow returns to step R2 to set and re-read the data again. If the corresponding predetermined number of retry attempts is reached, the flow proceeds to step R12 to confirm a reading failure, and then goes to step R6 to finish the reading process.

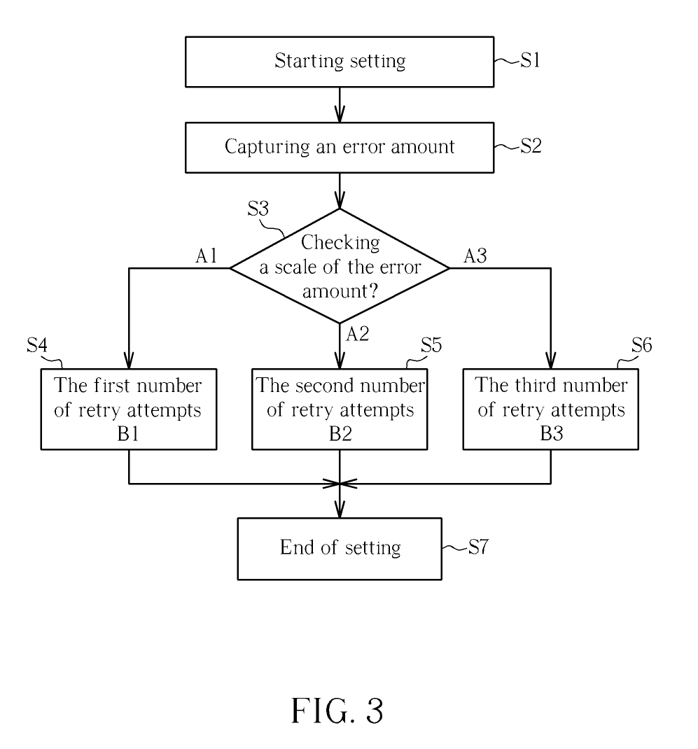

For example, in the aforementioned step R10, the number of retry attempts will be categorized into two scales: high and low. However, this is not supposed to be a limitation of the present invention; the number of retry attempts can be categorized into multiple scales. FIG. 3 is a flowchart of categorizing a number of retry attempts into three scales according to an embodiment of the present invention. Firstly, an error amount of correction and decoding is categorized into three scales according to their magnitude, i.e., the first error amount scale A1>the second error amount scale A2>the third error amount scale A3, and a corresponding predetermined number of retry attempts is set; that is, the first number of retry attempts B1<the second number of retry attempts B2<the third number of retry attempts B3.

In step S1, the setting of a number of retry attempts is started. In step S2, an error amount of correction and decoding in the aforementioned step R4 is captured. In step S3, a corresponding error amount scale of the error amount is checked according to the error amount scales A1, A2 and A3. If the error amount is located within the first error amount scale A1, which is higher, the flow goes to step S4 to set the number of retry attempts by the first number of retry attempts B1, which is lower than the others. If the error amount is located within the second error amount scale A2, which is in the middle, the flow goes to step S5 to set the number of retry attempts by the second number of retry attempts B2, which is also in the middle. If the error amount is located within the third error amount scale A3, which is lower, the flow goes to step S6 to set the number of retry attempts by the third number of retry attempts B3, which is higher than the others. After finishing all these settings, the flow proceeds to step S7 to finish the setting process.

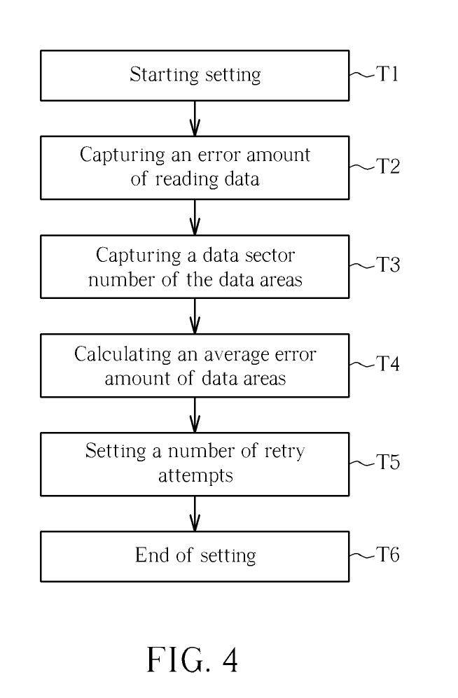

Please refer to FIG. 4, which is a flowchart of setting a number of retry attempts according to another embodiment of the present invention. Since each reading data area has different capacities, and an error amount of a larger data area is higher than an error amount of a smaller data area, referring only to error amounts during each reading process will make a larger data area harder to be read successfully. To derive a more accurate standard for setting a number of retry attempts, an average error amount, which is derived from an error amount of each reading area and data sectors of the data area, is referred to as a standard for adjusting setting a number of retry attempts.

In step T1, a process of setting a number of retry attempts is started. In step T2, the error amount of correction and decoding in the aforementioned step R4 is captured. In step T3, a data sector number of the data areas in the aforementioned step R3 is captured. In step T4, the error amount of correction and decoding is divided by the data sector number to derive an average error amount. In step T5, the average error amount and the predetermined error amount ranges are referred for adjusting a setting of the predetermined number of retry attempts, making a high error amount range correspond to a low number of retry attempts. Finally, in step T6, the setting process is finished.

Therefore, the reading method of optical disc drives of the present invention can set a predetermined number of retry attempts according to a data decoding error amount during a reading process, set a high number of retry attempts for data areas of low error amounts to increase a probability of successful reading. For data areas of a high error amount, the number of retry attempts is set lower to reduce retrying time, leading to an enhancement of reading efficiency. In addition, the reading method of optical disc drives in the present invention utilizes an average error amount of reading a data area as a standard for setting a number of retry attempts, leading to a more accurate number of retry attempts.

Those skilled in the art will readily observe that numerous modifications and alterations of the device and method may be made while retaining the teachings of the invention.

What is claimed is:

1. A reading method of optical disk drives, comprising:
(1) setting and reading data;
(2) decoding and correcting the data and calculating an error amount;
(3) detecting a reading error, setting to re-read the data, and accumulating a number of retry attempts by one;
(4) referring to the error amount, setting a low number of retry attempts as a threshold when the error amount is high; and setting a high number of retry attempts as a threshold when the error amount is low; and
(5) checking whether the number of retry attempts reaches the corresponding number of retry attempts threshold, when the number of retry attempts does not reach the corresponding number of retry attempts threshold, returning to step (1) to re-read the data; when the number of retry attempts reaches the corresponding number of retry attempts threshold, determining a reading error.

2. The reading method of claim 1, wherein in step (2) an error correction code (error correction code, ECC) is utilized to correct decoded data.

3. The reading method of claim 1, wherein step (2) further comprises:
(2-1) checking whether a reading error occurs resulting in the decoding and correction being unable to be performed; when no reading error occurs, transmitting the data; when a reading error occurs, going to step (3).

4. The reading method of claim 3, wherein step (2-1) further comprises:
(2-2) checking whether the transmission of the data is completed;
when the transmission is not completed, returning to step (1);
when the transmission is completed, finishing the reading process.

5. The reading method of claim 1, wherein the error amount is categorized into multiple scales and the number of retry attempts is set according to a corresponding range.

6. The reading method of claim 5, wherein the ranges, the error amount and the corresponding number of retry attempts are each categorized into three scales.

7. The reading method of claim 1, wherein step (4) further comprises:
(4-1) capturing data sector numbers of reading data;
(4-2) dividing the error amount by the data sector numbers to derive an average error amount; and
(4-3) setting a number of retry attempts according to the average error amount.

8. The reading method of claim 7, wherein when the average error amount of the data area is a high error amount range, the average error amount corresponds to a low number of retry attempts.
